(19) United States
(12) Patent Application Publication
(10) Pub. No.: US 2024/0263664 A1
(43) Pub. Date: Aug. 8, 2024

(54) Washer and Screw Connection System

(71) Applicant: Fraunhofer-Gesellschaft zur Foerderung der angewandten Forschung e.V., Munich (DE)

(72) Inventors: Saskia Nina BIEHL, Darmstadt (DE); Klaus LIPP, Darmstadt (DE); Andre JOECKEL, Darmstadt (DE); Martin GIETZEN, Darmstadt (DE); Joerg BAUMGARTNER, Darmstadt (DE); Julia JAKOBS, Braunschweig (DE); Marcel PLOGMEYER, Braunschweig (DE); Johannes WORM, Erlangen (DE); Johannes WIECZOREK, Erlangen (DE); Peter SPIES, Erlangen (DE)

(21) Appl. No.: 18/438,181

(22) Filed: Feb. 9, 2024

Related U.S. Application Data
(63) Continuation of application No. PCT/EP2022/072460, filed on Aug. 10, 2022.

(30) Foreign Application Priority Data
Aug. 11, 2021 (DE) 102021208777.9

(51) Int. Cl. F16B 31/02

(52) U.S. Cl. CPC F16B 31/028

(57) ABSTRACT

Washer, including: a carrier element; a counter element; and a sensory layer system arranged between the carrier element and the counter element and configured to output a sensor signal on the basis of a force prevailing between the carrier element and the counter element along a screw axis and/or a prevailing pressure force or vibration; wherein the carrier element and the counter element are arranged along a screw axis and wherein the carrier element includes a geometry that is engageable with a geometry of the counter element so as to limit or prevent a rotation between the carrier element and the counter element.

### CROSS-REFERENCES TO RELATED APPLICATIONS

This application is a continuation of copending International Application No. PCT/EP2022/072460, filed Aug. 10, 2022, which is incorporated herein by reference in its entirety, and additionally claims priority from German Application No. DE 10 2021 208 777.9, filed Aug. 11, 2021, which is incorporated herein by reference in its entirety.

Embodiments of the present invention relate to a screw connection system with a washer, and to the washer itself. Further embodiments relate to a method for manufacturing a screw connection by using a screw connection system and/or a washer.

### BACKGROUND OF THE INVENTION

DE 10 2010/001 144 A1 already discloses a screw connection system with a washer comprising a measurement of force. For example, the measurement of force may be carried out by means of a type of sensor layer or sensor disk. A relevant force to be sensed is the tensile force introduced into the connection element by the torque. This force is usually only measured when fastening, e.g. by means of a torque wrench, wherein the the sensor disk described herein enables monitoring the force in the state of being installed in a structure or the like. However, it is a problem that applying the torque by means of fastening the screw often leads to shearing movements in the area of the sensor disk or on the sensor layer applied onto the sensor disk so that the sensor disk may be damaged. Thus, there is a need for an improved approach.

It is the object of the present invention to provide a connection system with a sensor functionality that is optimized with respect to durability and ergonomics, in particular ergonomics in the installation.

### SUMMARY

An embodiment may have a washer, comprising: a carrier element; a counter element; and a sensory layer system arranged between the carrier element and the counter element and configured to output a sensor signal on the basis of a force prevailing between the carrier element and the counter element along a screw axis and/or a prevailing pressure force or vibration; wherein the carrier element and the counter element are arranged along a screw axis and wherein the carrier element comprises a geometry that is engageable with a geometry of the counter element so as to limit or prevent a rotation between the carrier element and the counter element. wherein the geometry of the carrier element is configured by an inner contour and/or comprises a tooth shape, a multi-tooth shape, or a hexagonal shape; and wherein the geometry of the counter element is configured by an outer contour and/or comprises a tooth shape, a multi-tooth shape, or a hexagonal shape; wherein the carrier element comprises a recess with an inner geometry, wherein the counter element comprises an outer geometry corresponding to the inner geometry of the carrier element.

Another embodiment may have a screw connection system, comprising: a screw element, in particular a screw, a nut, a bolt, a conventional screw, a DIN screw, a DIN nut, or a hexagonal screw; and a washer according to any one of the preceding claims, wherein the screw element extends through the washer along the screw axis.

Another embodiment may have a method for manufacturing a screw connection by means of a screw connection system according the invention, comprising: providing the washer; connecting, gluing or soldering the washer to the additional module; inserting the screw element; and tightening the screw element by transferring a torque onto the screw element by means of the additional module and the washer.

Another embodiment may have a method for manufacturing a screw connection by means of a connection system according the invention, comprising: providing the washer; screwing in the screw element by using the washer; attaching the additional module by using a clamp connection or screw connection.

### Aspect Washer

Embodiments of the present invention provide a washer with a carrier element, one or multiple counter elements as well as a sensor layer, or a sensory layer system, arranged between the carrier element and the counter element. The sensor layer element is configured to output a sensor signal on the basis of a force prevailing between the carrier element and the counter element along a screw axis, or a prevailing pressure force or vibration. The carrier element and the counter element are arranged along the screw axis, with the carrier element comprising a geometry that is engageable with a geometry of the counter element so as to limit or prevent a rotation between the carrier element and the counter element, in particular a rotation between the carrier element and the counter element around the screw axis. To this end, according to embodiments, the carrier element and the counter element may create a kind of form fit. Examples for such a form fit would be that the geometry of the carrier element comprises a radial inner contour, such as a tooth shape, a multi-tooth shape, or a hexagonal shape. According to embodiments, the geometry of the counter element could then form a radial outer contour, such as a tooth shape, a multi-tooth shape, or a hexagonal shape. In this case, it is advantageous (but not necessary) if the inner contour and the outer contour are adapted to each other so that the inner contour fits into the outer contour, for example, and is then able to perform a lateral movement along the screw axis, with the rotational movement around the screw axis then being limited.

At this point, it is to be noted that, according to embodiments, the screw axis is referred to as screw axis because a screw defining the screw axis can extend through the washer. For example, the screw axis is identical or parallel to the axis associated with the borehole of the washer. Thus, according to embodiments, the washer may comprise a hole and/or may represent a rotatory element having a hole (in its center).

Embodiments of this aspect of the invention are based on the finding that the use of a carrier element and one or multiple counter elements with an intermediate sensor layer system makes it possible to protect the intermediate sensor layer system. Firstly, this is achieved by the fact that no further components, such as the screw, can come into contact with the intermediate sensor layer system so that damage of the same is avoided. Secondly, a sheer movement, or surface damage, of the sensor layer system is avoided during fastening by the fact that the rotation between the carrier element and the counter element is limited. In this regard, embodiments of the present invention advantageously provide a sensor layer system in which monitoring of physical parameters, such as a force, is possible and the sensor layer is protected at the same time. This increases the reliability and service life as well as the ergonomics when fastening.

According to embodiments, the carrier element comprises a recess with the geometry of the carrier element as its radial inner geometry, wherein the counter element comprises a radial outer geometry corresponding to the geometry of the carrier element. In this case, the counter element may be placed into the recess of the carrier element. According to embodiments, the counter element may also be embedded into the recess. With respect to the dimensions, it is to be noted that the radial size of the recess is at least equal to the radial expansion of the outer geometry of the counter element, advantageously slightly larger. According to embodiments, a suitable outer geometry is a hexagonal shape and/or a wrench size (or width across flats or across-flats dimension). This creates one or multiple specified contact faces for the radial engagement between the carrier element and the counter element so that the rotation between these elements may be prevented effectively.

According to embodiments, the counter element may also be configured in multiple parts.

According to further embodiments, the sensor layer, or the sensory layer system, is arranged on a separate carrier embedded between the carrier element and the counter element. According to embodiments, the carrier element and/or the counter element comprises one or multiple specified contact faces (contact in the axial direction), such as bumps (with a reduced surface) on a main surface. They are used as contact faces to the sensor layer, or the sensory layer system. Overall, due to the contact faces, the axial force-transmitting surfaces are reduced (compared to the overall projection area of the component) and are advantageously defined in a precise way.

According to further embodiments, the sensory layer system is configured to output temperature signals on the basis of a prevailing temperature and/or to output a vibration signal (a vibration signal describing the vibration) on the basis of a prevailing vibration.

### Aspect Screw Connection System

According to further embodiments, the washer can be combined with a screw, in particular with a DIN screw/conventional screw. That is, an embodiment of the further aspect provides a screw connection system with a screw element, in particular a screw, a nut, a bolt, a conventional screw, a DIN screw, a DIN nut, or an (outer) hexagonal screw, which is combined with the washer. The screw elements extend through the washer/borehole of the washer along a screw axis.

Thus, embodiments of this aspect of the invention are based on the finding that the use of a conventional DIN screw, or a conventional screw in general, in connection with a washer, advantageously provides a sensor system. On the one hand, this has the advantage that a force, such as the tensile force or the force during fastening, can be monitored, wherein the installation is significantly simplified due to the above-described advantages, and cost-efficient components can be used at the same time.

### Aspect Screw Connection System with Additional Module

According to further embodiments, the connection system comprises an additional module that can be screwed on, screwed to, placed on, plugged on and/or clamped on the screw element, said additional module comprising an integrated electronic system or an integrated electronic system with an electronic evaluation system. For example, the electronic system may comprise an electronic evaluation system for the sensory layer stack of the washer as well as a corresponding power supply for the sensory layer stack and/or a radio module for transmitting the measurement data to the outside. Also, corresponding to further embodiments, an energy harvester may be present in the additional module. According to embodiments, the sensory layer stack is connected to the electronic system or the electronic evaluation system of the additional module via a cable. This cable may either extend across a contact connection on the side of the screw head or across a cable loop.

### Aspect Screw Connection System with Additional Module to be Plugged On

According to embodiments, the additional module can be plugged onto the screw head of the screw, i.e. it is larger than the screw and laterally extends along the screw head. For example, the additional module may comprise a recess for the head of the screw element, e.g. which is as deep as the screw head or even deeper than the screw head. According to embodiments, this recess makes it possible to then bring the additional module in contact with the washer. According to further embodiments, the additional module comprises a further recess, e.g. on a main surface opposite the main surface at which the recess for the screw head is provided. In this further recess, the electronic system/integrated electronic evaluation system may be integrated. Also, an energy harvester (solar harvester or thermal element harvester) may be provided here.

According to embodiments, the additional module is to be understood as a type of cap for the screw head or the screw element, i.e. it extends flush to the screw element, i.e. along an extension direction of the screw element (extension direction =screw axis).

Embodiments of this aspect of the invention are based on the finding that a third component, i.e. the additional module, makes it possible to accommodate the electronic system to be used for the sensory layer stack. For example, this electronic system encompasses the radio electronic system and/or the electronic evaluation system. Another advantage of this aspect is that standard components, such as DIN screws, may be used so that ergonomics in the installation are optimized. According to embodiments, e.g., the washer is connected to the screw and the screw element is tightened, wherein the additional module is subsequently plugged on.

### Aspect Screw Connection System with Torque-Transmitting Additional Module (Additional Module Including Engagement Portions)

According to a further embodiment, it would also be conceivable that the three elements washer, screw element and additional module are first connected to each other and are then screwed in together. According to embodiments, the outer contour of the washer is arranged flush to the outer contour of the additional module. The two of them, e.g. may comprise a hexagon/a wrench size so that they may be turned together. According to a further embodiment, the screw element is embedded into the additional module so that a rotation of the additional module causes a rotation of the screw element.

Thus, in this aspect with the additional module, there is a differentiation between the additional module that will subsequently be plugged on, clamped on, or screwed on the screw element, and an additional module that engages in a form-fitted connection with the screw element. According to a first variation, the additional module is plugged on after the screw is mounted, which has the advantage that conventional tools can be used.

According to the embodiment with the embedded screw head, the mechanical (torque-fitted) transfer of the additional module with the screw element is carried out prior to being screwed in. For example, the screw element may be placed through the additional module so that the torque is then applied to the additional module, wherein the additional module transfers its rotation/its torque onto the screw element. For example, it would be conceivable to connect the additional module with the washer in advance and to then place the screw through the additional module, or the washer coupled to the additional module.

According to an embodiment, the additional module comprises a recess with one or multiple engagement faces for the screw element or one or multiple engagement faces for the head of the screw element. For example, these engagement faces may be designed in the form of a type of wrench size/hexagon. In general, the engagement faces may be configured to transfer a torque onto the screw element. According to further embodiments, the recess of the additional module is hexagonal so that a hexagonal screw may be placed into the additional module and is thus rotated upon rotation of the additional module.

According to embodiments, the (radial) outer geometry of the attachable additional module is adapted to the (radial) outer geometry of the washer. This makes it possible that the additional module and the washer may be rotated at the same time. Alternatively or additionally, the outer geometry of the attachable additional module may be flush with the outer geometry of the washer. The background for this is that the additional module and the washer system comprise outer faces that make it possible to tighten the screw through rotation by means of a tool. For example, the outer geometry comprises a hexagonal shape so as to tighten the screw connection system by rotation with an open-end wrench, ring wrench or socket wrench. According to embodiments, the additional module is connected to the washer, e.g. it is glued or soldered to the same. The aspects “flush outer geometry” and “direct connection to the washer” are conceivable in both embodiments of the additional module, wherein the torque-transmitting design is advantageous. Particularly in the non-torque-transmitting version, gluing may be carried out afterwards.

According to a further embodiment, the additional module is screwed onto the washer, e.g. by means of separate screws. Alternatively or additionally, it can be clipped on by means of separate clips, e.g. lateral clips. All stated connection types (gluing, soldering, screwing, clipping) enable that compression is done between an electronic system component of the additional module and the screw element, both in the torque-transmitting design and the non-torque-transmitting design of the additional module. Through this, the screw element, or the element into which the screw element is screwed in, may be used as a temperature source or temperature sink. According to embodiments, the additional module comprises a thermogenerator in contact with the screw module (e.g. pressed onto the screw element) so as to create a thermally conductive connection. For example, the thermogenerator may use the screw as a temperature source or temperature sink, and may generate electric energy due to a temperature stroke between a surface of the additional module and the screw element. According to an embodiment, the additional module comprises cooling elements. Alternatively, the cooling elements may be formed by a surface of the additional module, e.g. a radial surface. This increases the surface of the cooling element.

According to an embodiment, the additional module comprises a rotated cable guide, e.g. a lateral cable guide or a cable guide in the area of the contact face to the washer. The electronic system of the additional module can be connected to the sensor layer through this cable guide. According to a further embodiment, the sensor layer can be connected to an electronic system via an external cable or a (pluggable) cable that can be connected externally. According to further embodiments, it would also be conceivable to electrically connect the additional module via a plug connection integrated into the additional module, and correspondingly into the washer system.

An advantage of the additional module is the possibility to use conventional screws that are tested and certified with respect to stress/strain and to integrate electric components, such as energy harvesters and/or electronic evaluation systems/radio electronic systems, into the additional module at the same time.

For the sake of completeness, it is to be noted that the additional module may also comprise a radio module and/or a battery and/or a solar cell and/or another energy harvester in addition to the electronic system/electronic evaluation system.

Further embodiments concern a method for manufacturing a screw connection by means of a screw connection system. In an embodiment, a screw connection system is used with a torque-transmitting additional module. The same includes following steps:
providing the washer;
placing in the screw elements;
connecting, gluing or soldering the washer to the additional modules; and
tightening the screw element by transmitting a torque to the screw element by means of the additional module and the washer.

The method may further include the step of integrating electronic systems and an energy supply, such as energy harvesting components, e.g. prior to connecting, gluing or soldering the washer to the additional module.

A further embodiment concerns manufacturing a screw connection by means of a connection system using an additional module that is plugged on. This method includes the following steps:
providing the washer;
screwing in the screw element by using the washer;
attaching the additional module using a clamp or screw connection (in this case, the additional module contains an electronic system and energy supply, for example).

### BRIEF DESCRIPTION OF THE DRAWINGS

Embodiments of the present invention will be detailed subsequently referring to the appended drawings, in which:

FIG. 1 shows a schematic illustration of a washer according to a base embodiment;

FIG. 2a shows a schematic illustration of a screw connection system with an attachable additional module according to an embodiment;

FIG. 2b shows a schematic illustration of a screw connection system with a torque-transmitting additional module according to an embodiment;

FIG. 3a-c show schematic illustrations of an additional module;

FIG. 4a-d show schematic illustrations of a washer in a 3D view according to embodiments;

FIG. 4e shows a schematic sectional view through an additional module in combination with a washer according to a further embodiment;

FIG. 4f-h show schematic illustrations of a combination of an additional module with a screw and a washer in three different exposition illustrations of the washer according to an embodiment;

FIG. 5 shows a schematic flow diagram to illustrate the assembly of a screw using a torque-transmitting additional module according to embodiments;

FIG. 6a-i show schematic illustrations of a screw connection system with a washer and an attachable additional module in 3D illustrations (a-d, h, g, j, k, l, n, o, p) as well as detailed views (m, e, f) and a sectional view (i);

FIG. 6j-p show schematic illustrations in a 3D view to illustrate a clip mechanism for the additional module according to embodiments;

FIG. 7 shows a schematic flow diagram to illustrate the assembly method of a screw connection system with an attachable additional module;

FIG. 8a-f show schematic illustrations of a screw connection system with a clippable additional module according to embodiments; and

FIG. 9a-d show schematic detailed illustrations of screw connection systems according to further embodiments.

### DETAILED DESCRIPTION OF THE INVENTION

Before embodiments of the present invention will subsequently be described on the basis of the accompanying drawings, it should be noted that elements and structures with the same effect are provided with the same reference numerals so that their description can be applied to each other or as interchangeable.

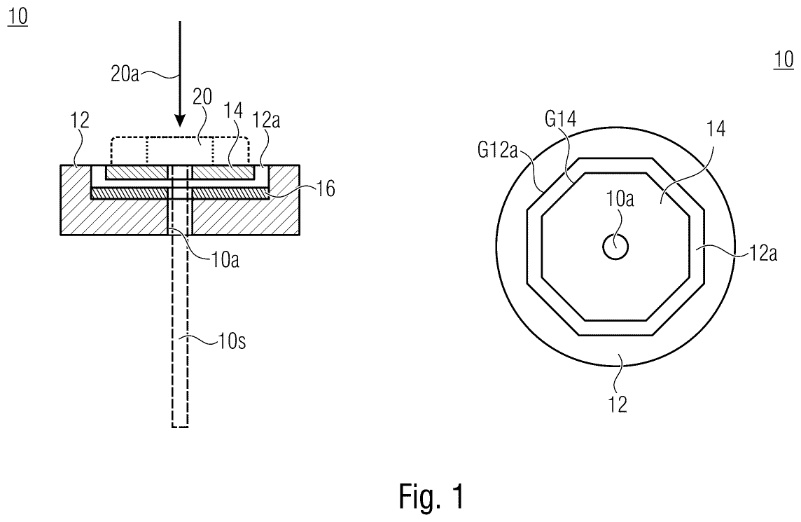

FIG. 1 shows a washer pack or washer 10 in two different views, i.e. a sectional view as well as a top view. The washer pack or washer 10 comprises a carrier element 12 and a counter element 14 as well as a sensory layer system 16. For example, the carrier element 12 comprises a recess 12a into which the counter element 14 is placed. According to embodiments, the recess 12a is configured so that it forms a positive fit (or form fit) with the outer contour of the counter element 14. For example, the inner geometry of the recess 12a may comprise a hexagonal shape, while the outer contour of the counter element 14 comprises a hexagon that has the same size or that is advantageously slightly smaller. Obviously, according to embodiments, other contours are also conceivable, such as a triangular shape, rectangular shape, or multi-tooth shape. An overall contour would also be possible. Due to the fact that the tolerances of the counter element 14 are smaller or minimally smaller (tolerance group H7/g6, e.g. 1% smaller or 5% smaller (in general in the range between 0.1% and 10% smaller, with respect to the diameter)), a movement of the counter element 14 relative to the carrier element is possible along the screw axis 20a, while a rotation around the screw axis is limited or prevented. This limitation of the rotation is achieved by the form fit or the interaction of the geometry g12a of the carrier element and g14 of the counter element in general.

After having described the geometry of the carrier and the counter element, a further essential feature will now be described. The washer comprises a sensory layer system 16 between the carrier element and the counter element. This layer system 16 maybe configured as a layer stack or as an individual layer, and includes a force-sensing or vibration-sensory layer, for example. According to embodiments, the sensory layer system 16 or the layer on the carrier element 12 maybe arranged/positioned in the recess 12a, for example, or may be arranged on the counter element 14 or between the elements 12 and 14. According to further embodiments, it would also be conceivable that an additional carrier layer is provided as part of the sensory layer system 16. In this respect, in this variation, the sensor layer of the sensory layer system is applied to an additional element and therefore forms the layer system 16, which is also referred as a sensor disc.

According to embodiments, the sensory laser system 16 is configured to sense a force prevailing between the carrier element and the counter element, in particular along the screw axis 20a, and to accordingly output a sensor signal describing the force, or the pressure force, or a vibration (variation of the pressure force, or force, across time). In this respect, it is advantageously possible to detect a force acting on the washer 10 along the screw axis 20, i.e. a pressure on the washer 10. According to embodiments, the same may be applied by a screw 20 inserted through an opening 10o of the washer 10. The opening 10o extends through the three components 12, 14 and 16 so that the screw shaft 10s is able to extend through the same.

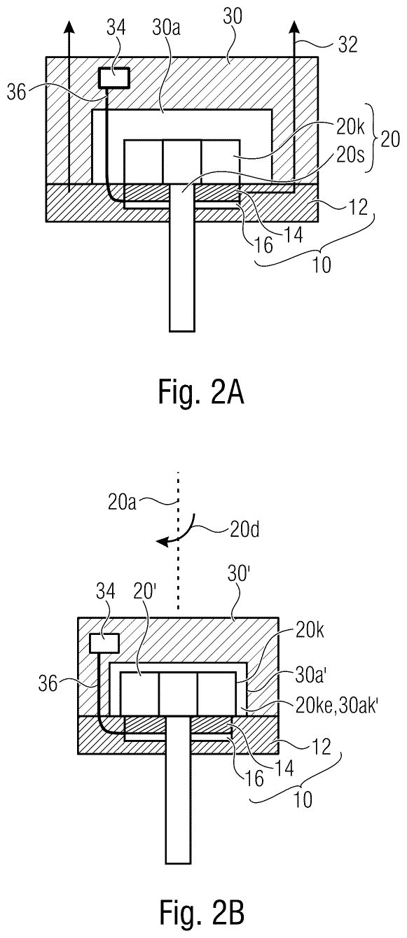

The combination of the optional screw 20 with the washer pack or washer 10 represents a screw connection system. This screw connection system may be enhanced by an additional module, e.g. in the form of a cap, as will be described in the following with reference to FIGS. 2a and 2b. FIG. 2a shows a screw 20 with a screw shaft 20s and a screw head 20k. For example, the screw may be a hexagonal screw, wherein further variations may also be used. The screw shaft extends through the disc 10 with the components 12, 14 and 16. This washer pack 10 maybe configured as described in connection with FIG. 1, for example. According to the embodiment of FIG. 2a, the screw connection system may further be enhanced by the additional module 30. The additional module 30 is placed onto, plugged onto, or clamped onto the screw head 20k. In this regard, in this embodiment or generally in corresponding embodiments, the additional module 30 has a recess 30a. In this embodiment, the recess 30a is configured so that the entire screw head 20k is enclosed in this recess 30a. As a consequence, the additional module 30 rests on the washer 10 with its first main surface, in which the recess 30a is arranged as well.

As initially mentioned, the additional module 30 maybe clamped on, clipped on, or screwed on. Here, as an example, a screwed-on variation fixing the additional module 30 by means of additional screws 32 is illustrated. In this embodiment, the additional module 30 is fixed to the washer 10.

According to embodiments, the additional module comprises an electronic system, such as an electronic evaluation system. The same is exemplarily arranged above the recess 30a and is provided with reference numeral 34. The electronic system/electronic evaluation system is used to evaluate the sensor signals/the sensory layer system 16 (with one or multiple sensory and non-sensory layers). According to embodiments, a cable connection 36 may be arranged between the element 34 and the sensory layer 16 or the sensory layer system 16. Here, the cable connection 36 extends through the recess 30a, wherein the same may also be configured differently. According to further embodiments, the electronic system 34 may be enhanced by further components, such as an energy supply, an energy harvester, a solar cell, a thermal harvester. According to further embodiments, it could also be enhanced by a radio module so that the sensor data could be transmitted to the outside.

This embodiment is advantageous in that a conventional screw 20 maybe used with the washer 10 enhanced by the sensor functionality, wherein an evaluation of the sensor data may be carried out by the additional module. The attachable additional module therefore makes it possible that each screw, e.g. in case of a screw compound, may monitor, e.g., the bridge construction, wherein the additional module is attached in a space efficient way. Often, the assembly ergonomics are particularly relevant in such screw connection systems. From an ergonomics point of view, this embodiment is particularly advantageous, since standard connection techniques are used and the additional module is later contacted and/or attached.

FIG. 2b shows a further optimization of an additional module 30′. The same may also be attached onto the screw 20 or in particular onto the screw head 20k in such a way that a torque can be transmitted from the additional module 30′ to the screw head 20k. This this end, the additional module 30′ comprises a recess 30a′ comprising a geometry adapted to the geometry of the screw head 20k. For example, on the basis of a hexagonal screw 20, the recess 30a′ may also be configured in a hexagonal shape, and comprises approximately a comparable size. Advantageously, the recess 30a′ has the same size or is slightly larger (e.g. 5% larger with respect to the diameter) or generally larger in the range of 0.1 to 10%. This results in an engagement between the additional module 30′ and the screw head 20k so that, in case of a rotation of the additional module 30′, the screw head 20k, or the screw, is rotated. The engagement portions are indicated with reference numerals 20ke and 30ak′. As a consequence, there is a transmission of the rotation (cf. rotation 20d) around the screw axis. Advantageously, this makes it possible that the additional module 30′ can be attached prior to screwing in the screw 20.

According to embodiments, the washer 20 with the sensory unit may also be assembled with the additional module 30′ and the screw 20 in advance. For example, the recess 30a′ is dimensioned so that the screw head 20k is received in its height. Thus, the screw head and the washer 10 are in contact again. For example, the additional module 30′ may be glued onto the washer 10.

According to embodiments, the additional module 30′ also comprises an electronic system or an electronic evaluation system 34 connected to the sensor layer 16 via a cable connection 36, for example.

At this point, it is to be noted that the additional module 30 or 30′ in the embodiment of FIG. 2a and in the embodiment of FIG. 2b is engaged with the washer 10 such that the force along the screw axis 20a is not affected. In the embodiment of FIG. 2a, the screw head 20k does not contact the additional module 30 so that a force-fit contact to the counter element 12 results only on the bottom side of the screw head 20k, wherein the carrier element 14 maybe in contact with a work piece (not illustrated). In the embodiment of FIG. 2b, the contact faces/engagement portions 20ke, 30ak′ may be configured after tightening so that there is no influence in the force direction along the axis 20a. In this case, the screw head 20k may be engaged with the counter element 12, wherein the carrier element 14 is then in contact with the work piece to be fixed and also with the additional module 30′. However, due to the reduced contact areas, the flow of force is not obstructed.

At this point, it is to be noted that the engagement portion between 20k and 30a′ is lateral, i.e. radial, via the contact faces 20ke and 30ak′, respectively.

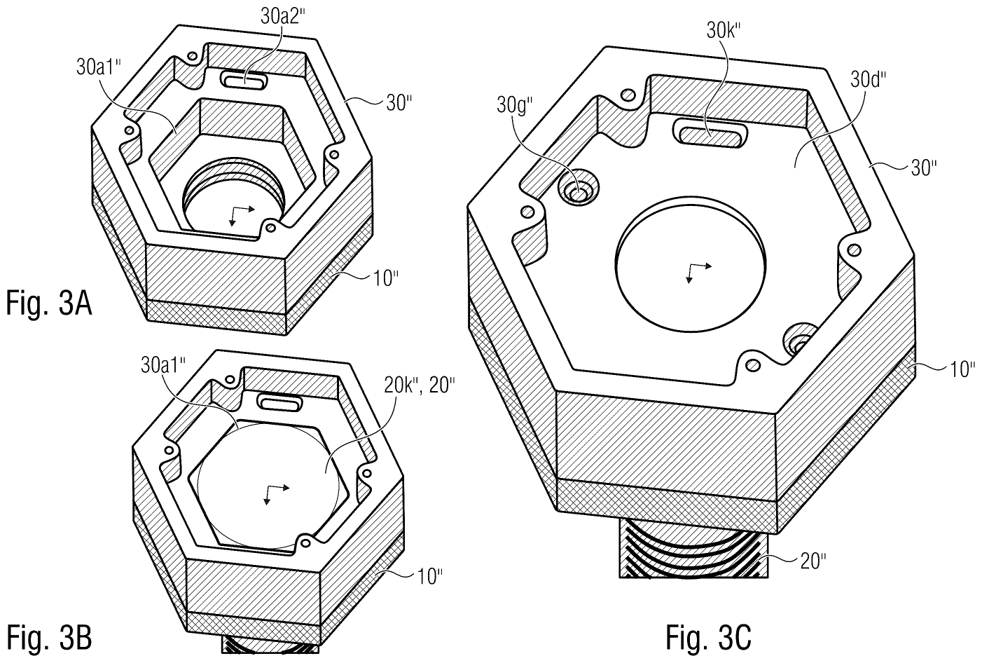

In the following, the screw connection system and in particular optional aspects of the screw connection system as well as the associated components are described with reference to FIGS. 3ff.

FIGS. 3a-c show a screw connection system with a screw 20″, a washer 10″, and an additional module 30″. FIG. 3a illustrates the combination of a washer 10″ and an additional module 30″. For example, they can be glued to each other. According to an embodiment, the additional module 30″ and the washer 10″ comprise a comparable shape, e.g. in the form of a wrench size. In this embodiment, the outer contours of the washer 10″ and of the additional module 30″ are flush. At this point, it is to be noted that the element 30″ may be configured as a metal housing, for example.

With respect to the nominal wrench size of the screw, it is to be noted that it is selected such that the metal housing 30″ is able to transmit the torque onto the screw 20″ or the screw head 20k″, when being screwed in. The principle is similar to that of a socket wrench and a screw head. At this point, it is to be noted that the degrees of freedom in the axial direction should not be limited so that fits/tolerances are selected accordingly.

According to embodiments, the additional module 30″ comprises a first and a second recess, here provided with the reference numerals 30a1″ and 30a2″. The first recess 30a1″ is located on the side of the washer 10″ and has a hexagonal shape, for example, so that a screw head can be placed in the same. This is illustrated in FIG. 3b. At this point, it is to be noted that the recess 30a1″ is able to extend through the entire component in the width of the screw head 20k″, and that the bottom side of the screw head 20k″ is held by the washer 10″, for example.

The additional module 30″ being made of metal has the advantage that this enables good heat dissipation. For example, assuming that a thermal harvester is provided in the additional module 30″, the temperature may be effectively dissipated, e.g. as a temperature sink or temperature source.

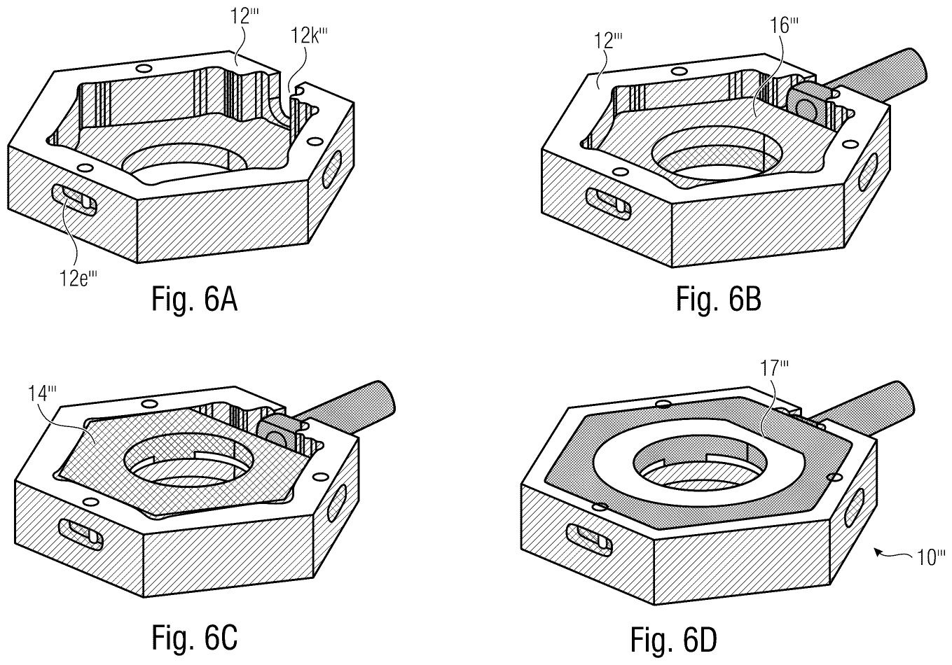

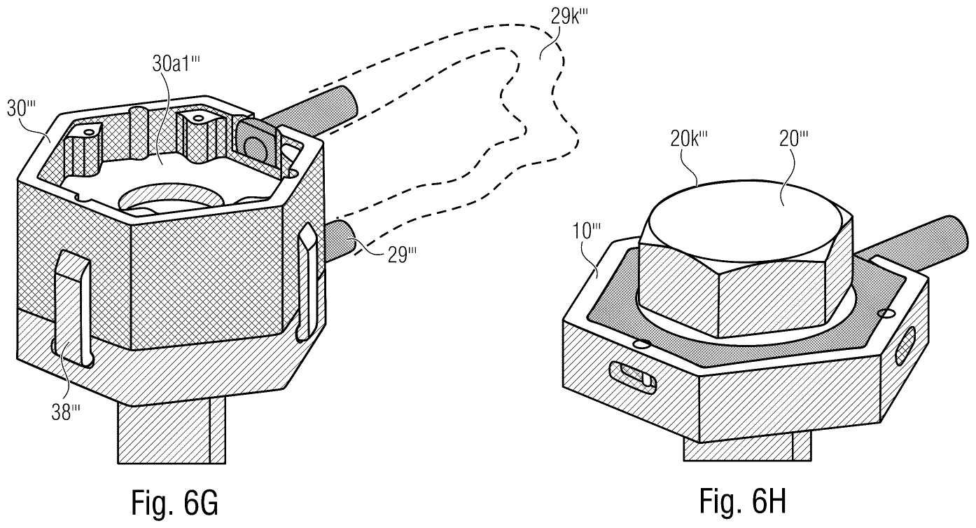

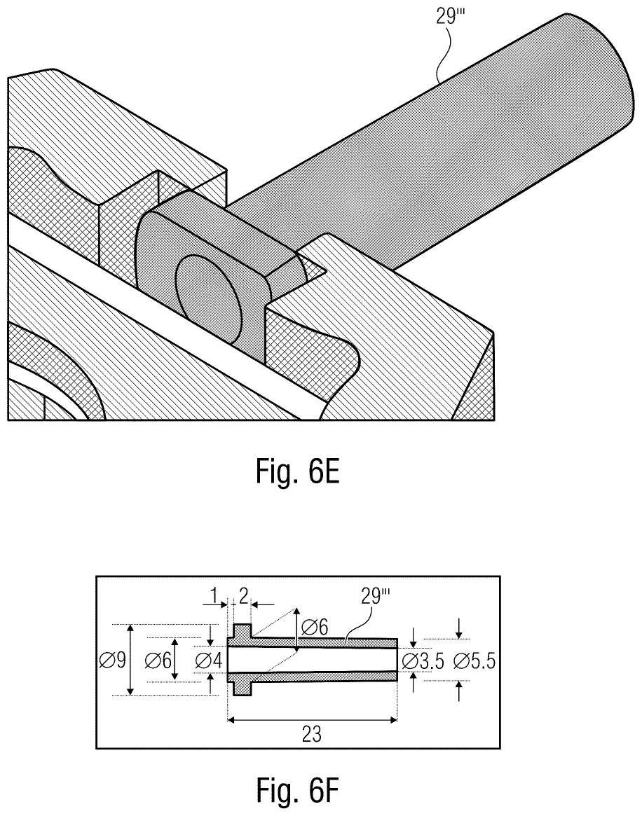

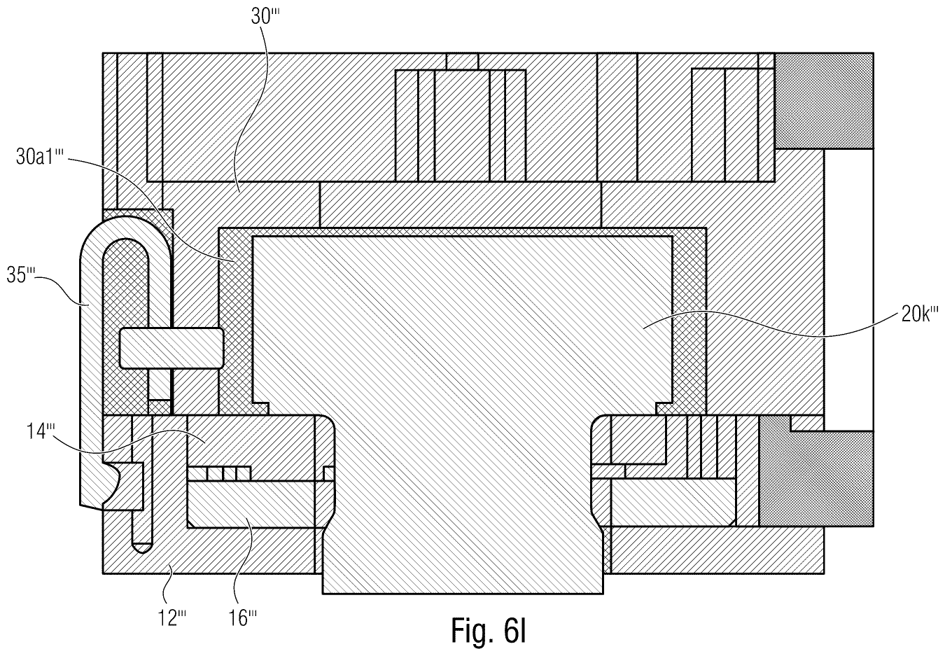

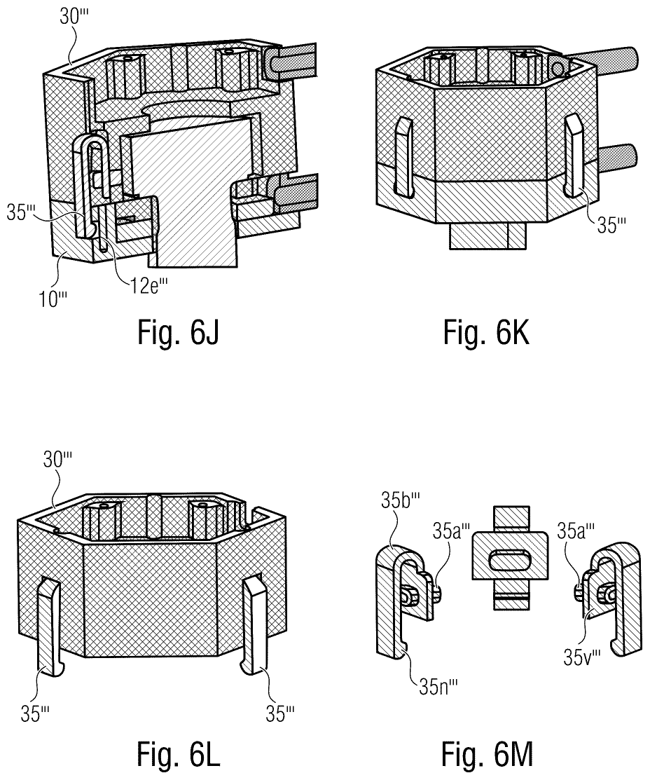

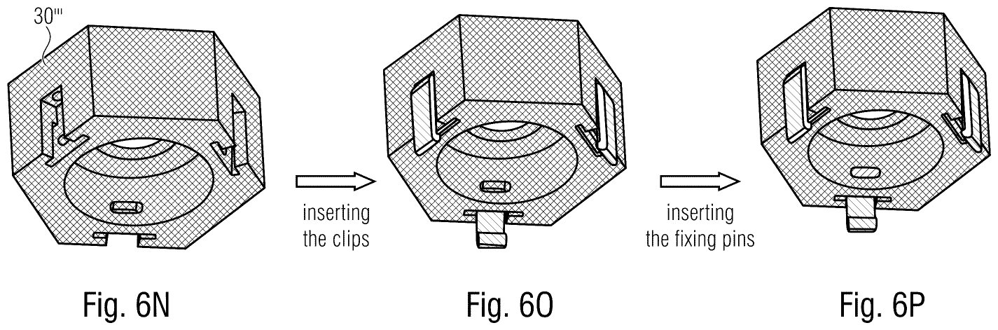

At this point, it is to be noted that a different temperature source or sink can here also form a screw, for example. Thus, a variation in which the thermogenerator is connected to the screw such that it acts as a temperature sink or temperature source is advantageous. With respect to FIGS. 6j-p, a clip-on element 35′″ is described. The same makes it possible to clip on a thermogenerator firmly onto a screw. Being clipped on firmly in such a way is also possible when being glued on or the like, according to further embodiments.

With respect to this embodiment or in general, it is to be noted that the thermogenerator is mounted into the additional module such that the side of the thermogenerator facing away from the screw has a thermally conductive connection to the additional module. In this case, the thermal resistance of the additional module should be as low as possible, which may be ensured by thermally highly conductive metal, for example. The additional module and the screw with the washer system are thermally decoupled from each other through a thermally poorly conductive element (insulator), according to embodiments.

As can be seen with reference to FIG. 3b, the screw head 20k″ is incorporated into the recess 30a1″. In this embodiment, the wrench size for the screw head 20″ is 27 mm, for example, wherein different tolerances (+4.1 and +0.05) can be used so that a torque transfer is carried out, however, the screw head 20k″ can be easily placed into the recess 30a1″, and there is no clamping. According to embodiments, the screw head 20k′' is flush with the plane area of the recess 30a″. For example, this area can be covered by means of a cap 30d″ so that there is a space for an electronic system or the like in the recess 30a″. It is to be noted that the cap 30d″ can be connected to the additional module by means of screws, for example. The screw holes are provided with the reference numerals 30s″. In addition, a cable feed-through 30k″ is provided, via which the electronic system can be connected to the sensor layer in the area 30a″. The cable feed-through 30k″ extends longitudinally through the entire component 30″, for example.

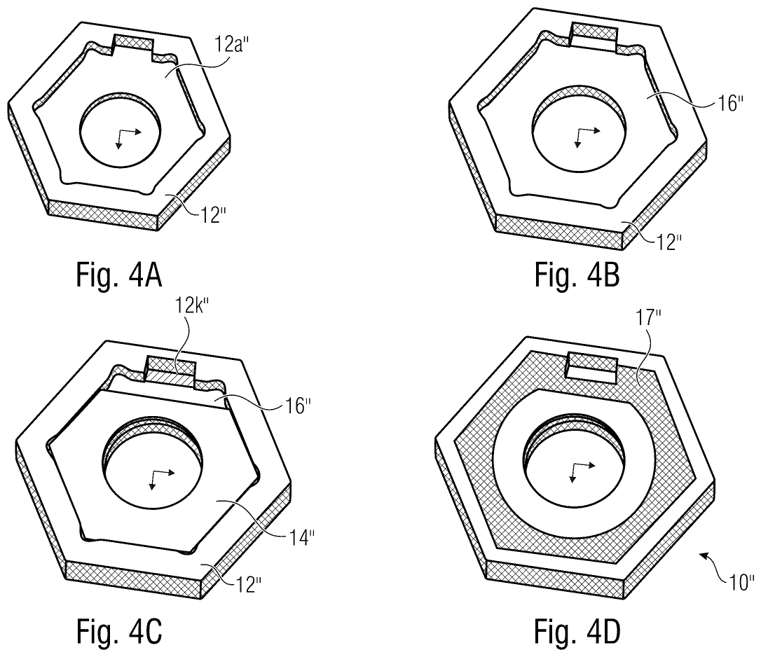

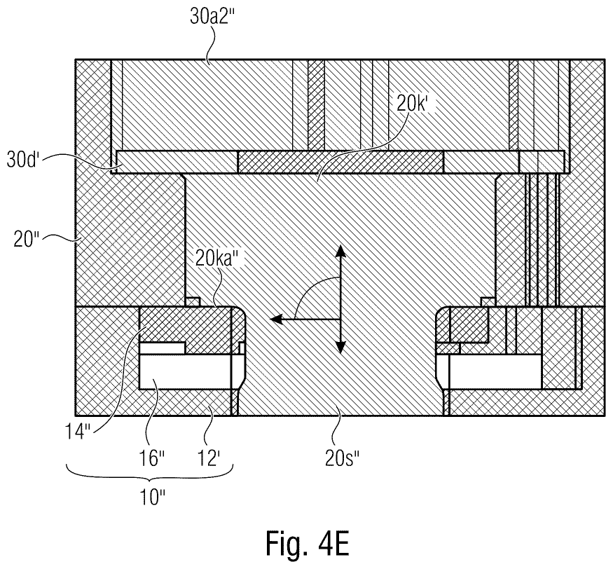

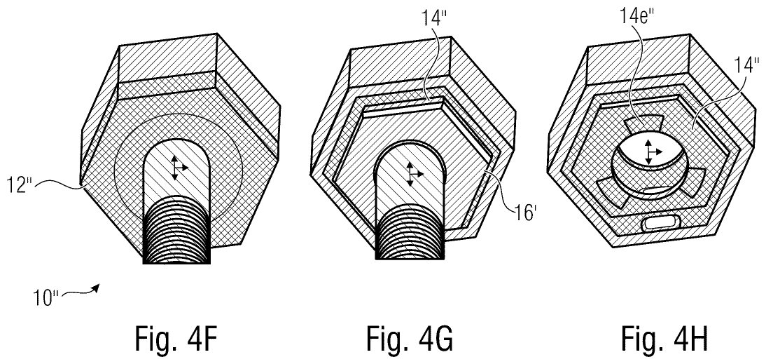

In the following, with reference to FIGS. 4a-d, the structure of the washer 10″ is described. The same comprises a carrier bed 12″. As can be seen, the washer 10″ is configured to be hexagonal and may have the same outer dimensions as the additional module 30″. The washer comprises a recess 12a″ (cf. FIG. 4a) into which the sensor layer or the sensory layer system 16″ can be placed (cf. FIG. 4b). The sensor layer 16″ is then embedded with the counter element 14″ (cf. FIGS. 4c-d). Furthermore, the counter element 14″ may be secured and sealed by the element 17″. As can be seen, an opening 12k″ via which the sensor element 16″ can be contacted is here also provided. In the screw connection system, a further disc may be engaged, as is shown with the element 17″ in FIG. 4d.

With respect to dimensioning, it is to be noted that the carrier element comprises a recess 12a″ with 35 mm, for example, while the counter element 14″ has the same diameter of 30 mm. The tolerances are different here as well. For example, a pairing H7/g6 may be selected so that the degree of freedom is the axial direction is not obstructed.

With respect to the dimensioning of the nominal wrench size for the housing 30″ (washer is inner hexagon) and the washer 10″ (external hexagon), the following is to be noted. The housing 10″ (washer pack) transfers the torque to the counter disc 12″ and the sensor disc 16″. A relative movement between the counter disc 12″ and the sensor disc 16″ should be as small as possible. By correctly selecting the tolerances, clamping between the washer 10″ (outer face) and the inner surface of the housing 30″ (washer pack) is avoided.

With reference to FIG. 4e, the effective areas are described again. The washer pack 10″ with the components 12″, 14″ and 16″ forms a unit through which the screw shaft 20s″ extends. In the area of the borehole through the washer pack 10″, there is enough space relative to the screw shaft 20s″ so that the screw head 20k″ affects the counter disc 14″ only via the seat face 20ka″ provided at the screw head 20k″. In this case, the diameter of the screw head 20k″, or the seat face 20ka″, is smaller than the diameter of the counter disc 14″ so that the force is transferred from the screw 20″ to the sensor disc 16″ via the counter disc 14″, and the measurement cannot be falsified here. Advantageously (but not necessarily), the additional module, or the housing 20″ of the additional module, rests on the carrier disc 12″, wherein the carrier disc 12″ and the counter disc 14″ are flush. Due to the tightening torque of the screw, the contact or the force effect from the housing 20″ to the sensor disc 16″ is then avoided.

An optional aspect of the counter disc 14″ is now described in connection with FIGS. 4f, g, and h. FIG. 4f shows in a three-dimensional illustration the washer 10″ and, in particular, the carrier element 12″ from below. FIG. 4g does not illustrate the carrier element 12″ so that the layers 14″ and 16″ are shown, while the carrier layer 12″ and the sensor layer 16″ are not illustrated in FIG. 4h, but only the counter disc 14″.

As can be seen in FIG. 4h, the counter disc 14″ comprises bumps 14e″ (three bumps in this case) on the side facing the sensor disc 16″. They have a specified size so that the introduction of force into the sensor disc 16″ is optimized.

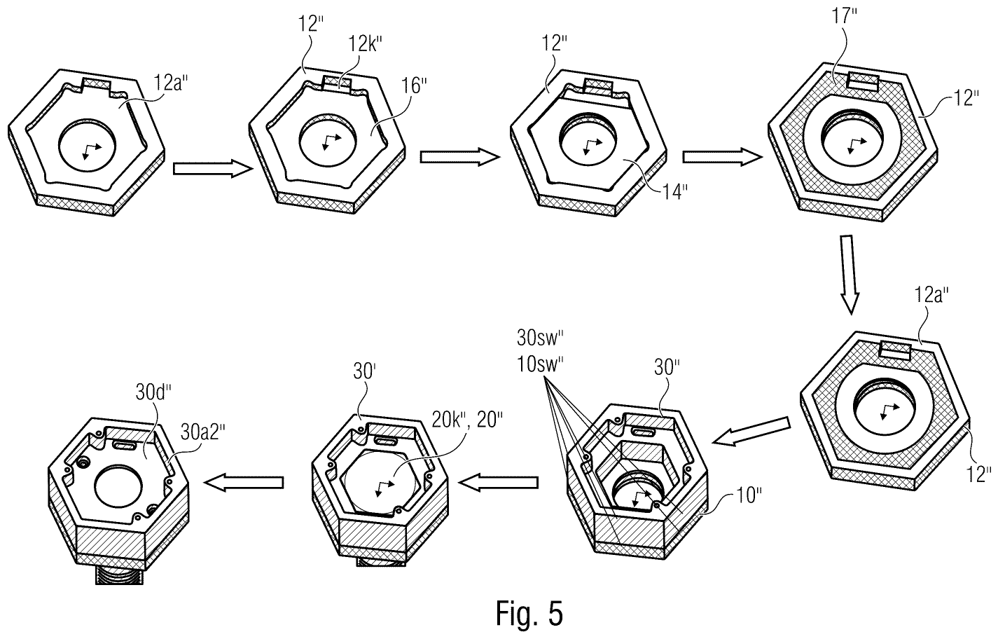

Subsequently, the installation process or assembly process of the washer 10″, the additional module 30″, and the screw 20″ is described with reference to FIG. 5e.

In a first step, the carrier disc 12″ is provided so that the sensor disc 16″ can be placed in and the cables can be guided laterally (cf. cable guides 12k″) in the next step. In a next step, the counter disc 14″ is then placed in and glued to the cover sheet 17″ (optional element). After positioning the cover sheet 17″ and curing the adhesive, further adhesive is then applied onto the free surface of the element 12″. This surface is here marked with reference numeral 12o″. The metal body, or the body in general, of the additional module 30″ is then to be glued on via this adhesive connection. To this end, for example, the following steps are carried out: guiding cables through an opening in the metal housing 30″; placing the metal housing 30″ and positioning the same and weighing the same down by means of weights, for example, so as to improve curing. The faces 30sw″ or 10sw″ form the lateral wrench size. Advantageously, the faces 30sw″ and 10sw″ are flush so that the torque can be uniformly transferred in the final assembly with the inner hexagonal socket wrench to both housings 30″ and 10″.

After the elements 30″ and 10″, the screw 20″ may be placed in. The size of the screw, or in particular of the screw head 20k″, is adapted to the recess 30a1″, as described above. In a final step, a protective disc 30d″ may be inserted into the recess 30a″, representing a protection for the electronic system or the like. Subsequently, the electronic system is inserted and further cover plate (not illustrated) is used for closing.

A further alternative is described with reference to FIG. 6.

FIGS. 6a-d illustrate a washer 10′″ also comprising a hexagonal shape. The washer consists of the following elements: a carrier disc 12′″, a sensor disc 16′″, a counter disc 14′″, and a cover disc 17′″. The structure is as described in connection with FIGS. 4a-d, for example. However, it is to be noted that a lateral cable exit 12k′″ and engagement portions 12e′″ may be present here. The cable is guided out through a cable support sleeve 29′″ via this cable exit 12k′″. This makes it possible to couple an electronic system located in the recess 30a2′″ (cf. FIG. 6g). The associated cable is provided with reference numeral 29k′″.

Before placing the additional module 30′″, as illustrated in FIG. 6, the screw 20′″ is connected to the washer 10′″. Here, the screw 20′″ may be screwed in directly into a body without already having the additional module placed. Through the cable 29k′″, the additional module 30′″ may then be located next to the screw so that the screw 20′″ can be tightened. In a next step, the additional module 30′″ is then placed onto the screw head 20k′″, as can be seen in the sectional view. In this embodiment, the recess 30a1′″ is not necessarily adapted precisely to the shape of the screw head 20k′″, but can also be larger. A round recess 30a′″ according to the maximum diameter of the screw head 20k′″ would also be conceivable. From corresponding embodiments, the additional module 30′″ on the screw via a clip 35′″ also becomes conceivable. This clip 35′″ is laterally attached to the additional module 30′″ and engages with the engagement portions 12e′″ so as to avoid axial slipping of the additional module 30′″. In this embodiment, three clips 35′″ are provided, i.e. on each of the second side faces of the wrench size.

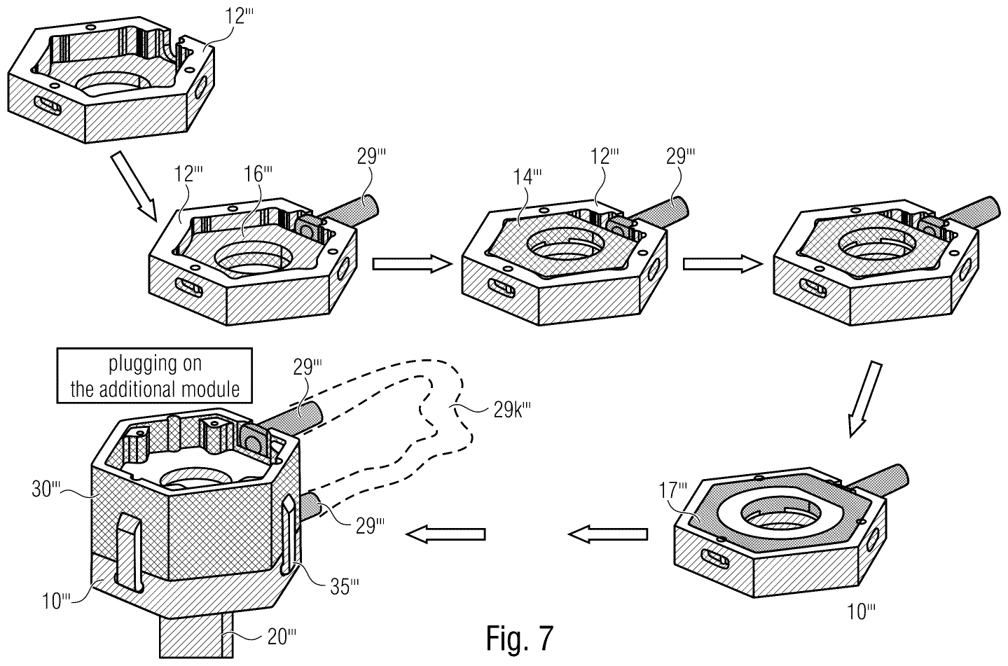

Starting from the connection system of FIG. 6, the assembly is now described on the basis of FIG. 7. In a first step, the carrier element 12′″ is provided so that the sensor disc 16′″ can be inserted in the next step. In this case, the cable 29k′″, or the cable support sleeve 29′″, projects laterally. In a subsequent step, the counter disc 14′″ is inserted, wherein the bend protection sleeve 29″″ is also glued in, if applicable. In a subsequent step, the cover sheet 17′″ is glued on so as to be positioned, completing the assembly of the washer 10′″. On the side of the additional module, the cable is then guided through the cable tube or the bend protection sleeve 29″″, wherein the cable tube is placed over the two bend protection sleeves each and may also be glued, if applicable. After that, the protection sleeve 29″″ is placed into the additional module 30′″ so that the electronic system may then be inserted. When the screw 20′″ is mounted, the additional module 30′″ may be placed onto the screw 20′″, or the washer 10′″. The same is fixed by means of the clips 35′″.

The clip 35′″ is now described in detail with reference to FIGS. 6j-p. As described above, the same is used to fasten the additional module 30′″ on the washer 10′″ so as to realize axial fastening. As shown in FIGS. 6j or k, the clips 35′″ are arranged laterally and are initially provided with the additional module 30′″. As is illustrated in FIG. 6m, each clip includes a folded bracket and an anchor 35a′″. The folded bracket 35b′″ enables a spring movement, while the anchor 35a′″ is used to connect the clip to the base body of the additional module 30′″. For example, this is shown in FIG. 6j. The connection is carried out so that the bracket 35b′″ comprises an enlargement in the area of the anchor 35a′″ (cf. 35v′″) so that the same can be guided into the base body or in a type of undercut of the base body 30′″. The anchor 35a′″ forms a fixing pin and may be inserted afterwards, as illustrated in FIGS. 6m, o and p. As a consequence of being fixed, the bracket 35b′″ can be bent towards the outside and makes it possible to apply a force onto the washer 10′″. The bracket 35′″ with its latching nose 35n′″ latches into the engagement portion 12e′″.

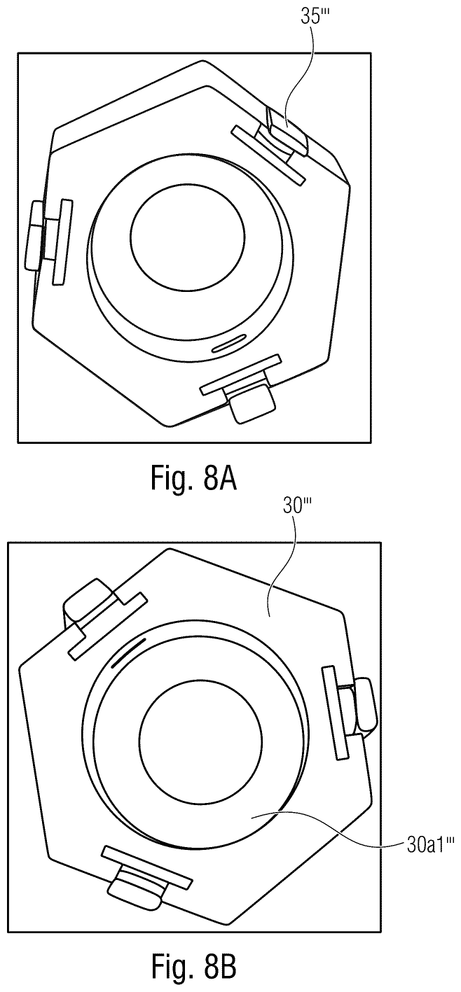

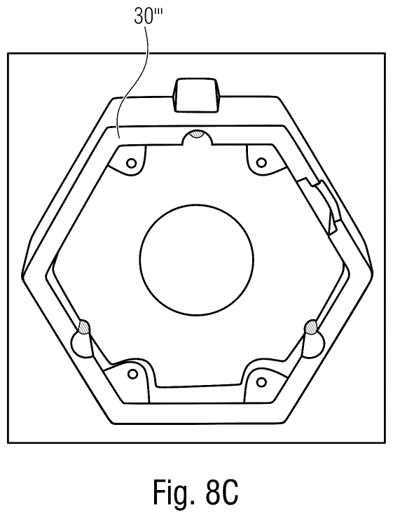

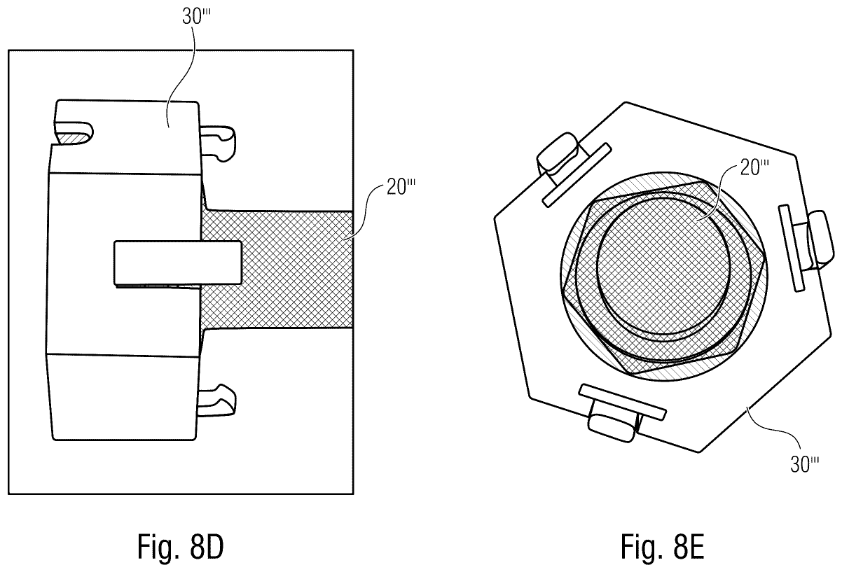

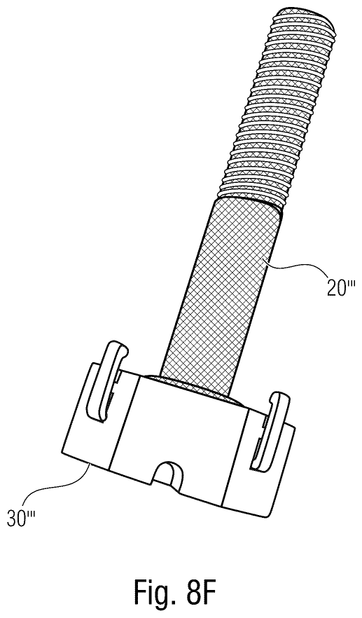

FIGS. 8a and b shows the fixing clips 35′″ inserted into the base body of the additional module 30′″. This embodiment assumes a plastic housing. As can be seen here or also in FIG. 6p, the recess 30a1′″ is not configured, i.e. not implemented to transfer a torque onto the screw. FIGS. 8d, e and f show the connection of the additional module 30′″ to the screw 20′″.

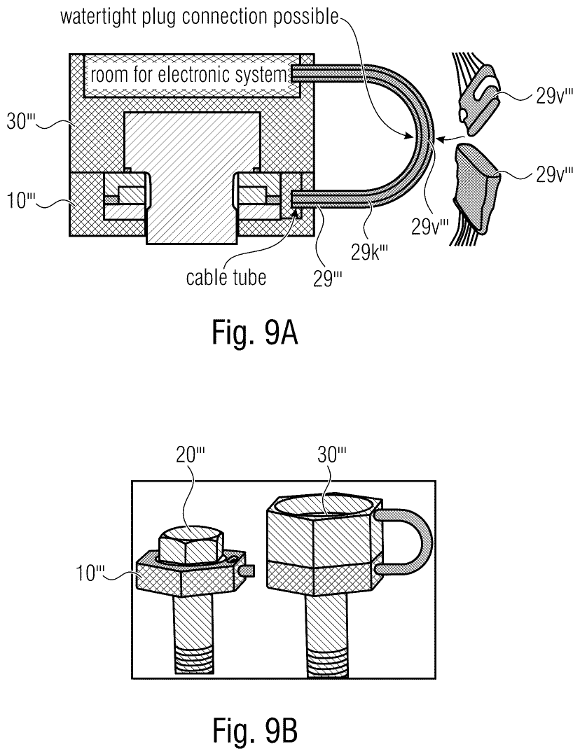

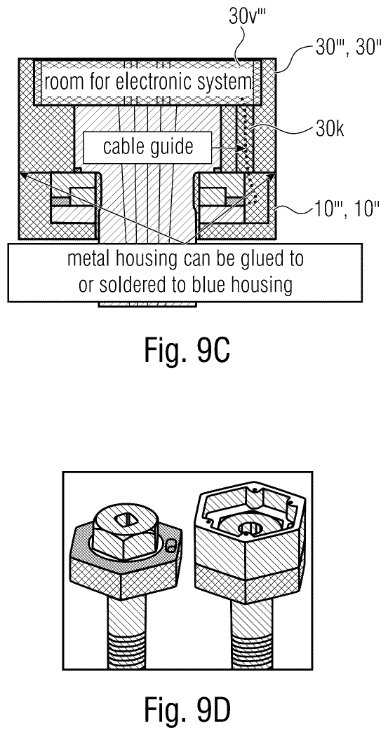

Two different variations of the cable guide are now described with reference to FIG. 9. The variation of FIGS. 9a and b is essentially identical to the variation of FIG. 6g. The cable 29k′″ is guided out from the washer 10′″ laterally by means of a cable shoe or a cable tube 29′″. The cable 29k′″ is analogously guided into the additional module 30′″. To simplify assembly, a water-tight plug connection 29v′″ may be provided. This plug connection 29v′″ may help fixing the washer 10′″ to the screw 20′″ first, before attaching the additional module 30′″ with its electronic system (cf. FIG. 9b) in a subsequent step.

FIG. 9c shows a further variation of the cable guide. Here, the additional module 30″ or the additional module 30′″ comprises an internal cable guide 30k. The same extends through the base body of the additional module 30″ or 30′″ from the recess 30b′″ towards the washer 10″ or 10′″. This variation is advantageous if the additional module 30″ is glued to the washer 10″ prior to assembly. This is illustrated in such a way in FIG. 9d.

At this point it is to be noted that the embodiments are purely illustrative, while the protective scope is specified by the subsequent claims.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### LIST OF REFERENCE NUMERALS

Washer (10, 10′, 10″, 10′″)
Carrier Element (12, 12′, 12″, 12′″)
Counter Element (14, 14′, 14″, 14′″)
Sensory Layer System (16, 16′, 16″, 16′″)
Inner Contour (12a)
Inner Geometry (g12a)
Outer Geometry (g14)
Recess (12a)
Screw Element (20, 20′, 20″, 20′″)
Screw Axis (20a)
Electronic evaluation system (34)
Additional Module (30, 30′, 30″, 30′″)
Recess in the Additional Module (30a2″)

1. Washer, comprising:
a carrier element;
a counter element; and
a sensory layer system arranged between the carrier element and the counter element and configured to output a sensor signal on the basis of a force prevailing between the carrier element and the counter element along a screw axis and/or a prevailing pressure force or vibration;
wherein the carrier element and the counter element are arranged along a screw axis and wherein the carrier element comprises a geometry that is engageable with a geometry of the counter element so as to limit or prevent a rotation between the carrier element and the counter element.
wherein the geometry of the carrier element is configured by an inner contour and/or comprises a tooth shape, a multi-tooth shape, or a hexagonal shape; and wherein the geometry of the counter element is configured by an outer contour and/or comprises a tooth shape, a multi-tooth shape, or a hexagonal shape;
wherein the carrier element comprises a recess with an inner geometry, wherein the counter element comprises an outer geometry corresponding to the inner geometry of the carrier element.

2. Washer according to claim 1, wherein the carrier element and the counter element form a form fit.

3. Washer according to claim 1, wherein the counter element is inserted into the recess of the carrier element.

4. Washer according to claim 1, wherein the sensory layer system is arranged on a separate carrier embedded between the carrier element and the counter element.

5. Washer according to claim 1, wherein the carrier element comprises a outer geometry with a hexagonal shape and/or a wrench size.

6. Washer according to claim 1, wherein the carrier element and/or the counter element comprises one or more specified contact faces or specified bumps opposite the sensory layer system.

7. Washer according to claim 1, wherein the sensory layer system is configured to output a temperature signal on the basis of a prevailing temperature; and/or
wherein the sensory layer system is configured to output a vibration signal describing a vibration on the basis of a prevailing vibration.

8. Screw connection system, comprising:
a screw element, in particular a screw, a nut, a bolt, a conventional screw, a DIN screw, a DIN nut, or a hexagonal screw; and
a washer according to any one of the preceding claims, wherein the screw element extends through the washer along the screw axis.

9. Screw connection system according to claim 8, wherein the connection system comprises an additional module that can be placed onto, plugged onto and/or clamped onto the screw element, wherein the additional module comprises an integrated electronic system or an integrated electronic system with an integrated electronic evaluation system, or
wherein the connection system comprises an additional module that can be placed onto, plugged onto and/or clamped onto the screw element, wherein the additional module comprises an integrated electronic system or an integrated electronic system with an integrated electronic evaluation system and wherein the additional module comprises a recess for a head of the screw element and/or a recess for the integrated electronic system or the integrated electronic system and the integrated electronic evaluation system and/or wherein the additional module is arranged so as to be flush to the screw element or to an extension direction of the screw element; or
wherein the connection system comprises an additional module that can be placed onto, plugged onto and/or clamped onto the screw element, wherein the additional module comprises an integrated electronic system or an integrated electronic system with an integrated electronic evaluation system and wherein the additional module comprises a recess for a head of the screw element and/or a recess for the integrated electronic system or the integrated electronic system and the integrated electronic evaluation system and/or wherein the additional module is arranged so as to be flush to the screw element or to an extension direction of the screw element; and/or wherein the connection system comprises an additional module with an integrated electronic system or with an integrated electronic system and an integrated electronic evaluation system, wherein the screw element is embedded into the additional module so that a rotation of the additional module causes a rotation of the screw element; or
wherein the connection system comprises an additional module that can be placed onto, plugged onto and/or clamped onto the screw element, wherein the additional module comprises an integrated electronic system or an integrated electronic system with an integrated electronic evaluation system and wherein the additional module comprises a recess for a head of the screw element and/or a recess for the integrated electronic system or the integrated electronic system and the integrated electronic evaluation system and/or wherein the additional module is arranged so as to be flush to the screw element or to an extension direction of the screw element; and/or wherein the connection system comprises an additional module with an integrated electronic system or with an integrated electronic system and an integrated electronic evaluation system, wherein the screw element is embedded into the additional module so that a rotation of the additional module causes a rotation of the screw element and wherein the additional module comprises a recess with one or multiple engagement faces for the screw element or one or multiple engagement faces for a head of the screw element or one or multiple engagement faces for a wrench size of the screw element; and/or wherein the one or the multiple engagement faces are configured to transfer a torque to the screw element; and/or wherein the additional module comprises a hexagonal recess.

10. Screw connection system according to claim 9, wherein the additional module comprises an outer contour in the form of a wrench size.

11. Screw connection system according to claim 9, wherein the additional module comprises a thermogenerator in contact with the screw element and/or pressed onto the screw element so as to create a thermally conductive connection.

12. Screw connection system according to claim 9, wherein the outer geometry of the attachable additional module is adapted to the outer geometry of the washer and/or wherein the outer geometry of the attachable additional module is flush with the outer geometry of the washer.

13. Screw connection system according to claim 9, wherein the additional module is connected, glued, or soldered to the washer.

14. Screw connection system according to claim 9, wherein the additional module is screwed onto the washer or wherein the additional module is screwed onto the washer by means of separate screws; or
wherein the additional module is clipped onto the washer by means of clips.

15. Screw connection system according to claim 13, wherein a compression between an electronic component and the screw element is ensured through the connection, gluing, soldering, or screwing.

16. Screw connection system according to claim 9, wherein the additional module comprises an integrated cable guide so that an electronic system of the additional module can be connected to the sensor layer; and/or
wherein the sensor layer can be connected to the electronic system via an external cable or a cable that can be connect externally.

17. Screw connection system according to claim 9, wherein the additional module comprises a cooling element or a surface configured as a cooling element and/or a radial surface configured as a cooling element.

18. Screw connection system according to claim 9, wherein the additional module comprises a radio module, a battery, or a solar cell.

19. Method for manufacturing a screw connection by means of a screw connection system according to claim 9, comprising:
providing the washer;
connecting, gluing or soldering the washer to the additional module;
inserting the screw element; and
tightening the screw element by transferring a torque onto the screw element by means of the additional module and the washer.

20. Method for manufacturing a screw connection by means of a connection system according to claim 9, comprising:
providing the washer;
screwing in the screw element by using the washer;
attaching the additional module by using a clamp connection or screw connection.
